(19) United States
(12) Patent Application Publication
(10) Pub. No.: US 2025/0060459 A1
(43) Pub. Date: Feb. 20, 2025

(54) INCREASING SENSOR FREQUENCY

(71) Applicant: GM Cruise Holdings LLC, San Francisco, CA (US)

(72) Inventor: Sandeep Gangundi, San Jose, CA (US)

(21) Appl. No.: 18/450,693

(22) Filed: Aug. 16, 2023

(51) Int. Cl. G01S 7/4861; G01S 17/42

(52) U.S. Cl. CPC G01S 7/4861; G01S 17/42

(57) ABSTRACT

The present disclosure generally relates to techniques to increase the functional frequency of a LIDAR sensor of an autonomous vehicle without increasing the physical frequency. In some aspects, a method of the disclosed technology includes steps for collecting, using a LIDAR sensor of an autonomous vehicle (AV), first sensor data during a first portion of a scan performed by the LIDAR sensor; collecting, using the LIDAR sensor of the autonomous vehicle, second sensor data during a second portion of the scan performed by the LIDAR sensor, the first sensor data and the second sensor data measuring different portions of a scene; skipping collection of additional sensor data during a third portion of the scan performed by the LIDAR sensor; and estimating the additional sensor data based on a field-of-view (FOV) of the LIDAR sensor during the third portion of the scan. Systems and machine-readable media are also provided.

### BACKGROUND

### 1. Technical Field

The present disclosure generally relates to techniques for increasing the functional frequency of a light detection and ranging (LIDAR) sensor and, more specifically, collecting LIDAR data during a first part of a LIDAR scan and estimating additional LIDAR data corresponding to a second part of the LIDAR scan.

### 2. Introduction

Sensors are commonly integrated into a wide array of systems and electronic devices such as, for example, camera systems, mobile phones, autonomous systems (e.g., autonomous vehicles, unmanned aerial vehicles or drones, autonomous robots, etc.), computers, smart wearables, and many other devices. The sensors allow users to obtain sensor data that measures, describes, and/or depicts one or more aspects of a target such as an object, a scene, a person, and/or any other targets. For example, a light ranging and detection (LIDAR) sensor can be used to determine ranges (variable distance) of one or more targets by directing a laser to a surface of an entity (e.g., a person, an object, a structure, an animal, etc.) and measuring the time for light reflected from the surface to return to the LIDAR.

### BRIEF DESCRIPTION OF THE DRAWINGS

The various advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 illustrates an example system environment that can be used to facilitate autonomous vehicle (AV) dispatch and operations, according to some aspects of the disclosed technology;

FIG. 2A illustrates a diagram of an example LIDAR sensor, according to some examples of the present disclosure;

FIG. 2B illustrates a diagram of an example LIDAR sensor using estimation techniques to increase the functional frequency of a LIDAR sensor without increasing the actual, physical frequency of the LIDAR sensor, according to some examples of the present disclosure;

FIG. 3 illustrates a flow diagram of an example process for increasing the functional frequency of a LIDAR sensor without physically increasing the frequency, according to some examples of the present disclosure;

FIG. 4 illustrates a flow diagram of an example process for increasing the functional frequency of a LIDAR sensor without physically increasing the frequency, according to some examples of the present disclosure;

FIG. 5 illustrates an example of a deep learning neural network that can be used to estimate the location of objects within a field of view of a LIDAR scanner, according to some aspects of the disclosed technology; and

FIG. 6 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring the concepts of the subject technology.

Some aspect of the present technology may relate to the gathering and use of data available from various sources to improve safety, quality, and experience. The present disclosure contemplates that in some instances, this gathered data may include personal information. The present disclosure contemplates that the entities involved with such personal information respect and value privacy policies and practices.

Autonomous vehicles (AVs) can navigate roadways without a human driver based on sensor signals generated by multiple sensor systems, as discussed in more detail below. One type of sensor that can be used by AVs to help navigate roadways is a light detection and ranging (LIDAR) sensor. In some examples, a LIDAR sensor can emit light waves into the environment that can reflect from surrounding objects and return to the sensor. The LIDAR sensor can calculate the distance that the light waves travelled based on how long it takes for a light wave to return to the sensor. In some examples, the LIDAR sensor can rotate a certain amount of degrees, such as 360 degrees, as it emits and receives the light waves, and this process can be repeated to create a map of the AV's environment. In some examples, the LIDAR sensor can rotate less than 360 degrees, such as, for example, when the LIDAR sensor has a blind spot, the LIDAR sensor can skip the blind spot. The AV can subsequently use this map of the surrounding environment to navigate the environment without a human driver.

The frequency of a LIDAR sensor can be defined as the number of times that the LIDAR sensor rotates per second while collecting data and/or the amount of time it takes the LIDAR sensor to complete a scan from a beginning position and/or field-of-view (FOV) of the LIDAR sensor during the scan to an end position and/or FOV of the LIDAR sensor during the scan. In practice, the higher the frequency of a LIDAR sensor (e.g., the faster the LIDAR sensor rotates, thereby increasing the number of iterations of emitting and receiving reflected light waves per second), the more data that the LIDAR sensor can collect and/or the faster that the LIDAR sensor can collect data. For example, the more times the LIDAR sensor rotates per second, the more data the LIDAR sensor can capture. The frequency of a LIDAR sensor can be dependent on one or more factors. For example, in the context of a LIDAR sensor implemented by an AV, if the AV is stationary or moving slowly (e.g., below a threshold speed), the AV can achieve accurate results using a LIDAR sensor operating at a lower frequency than an AV travelling at a higher rate of speed. When an AV is travelling at a higher rate of speed, the objects in its environment can be proximate to the AV for a much shorter period of time compared to an AV that is stationary (or slowly moving).

The ability to physically increase the frequency of a LIDAR sensor can be limited by several factors. In some examples, the hardware of a LIDAR sensor can limit the frequency of the LIDAR sensor. In other examples, computing resources and bandwidth can limit the operational frequency of a LIDAR sensor. For example, each reflected light wave captured by the LIDAR sensor constitutes an amount of data to be stored in computer storage, which can be limited. Additionally, an increased number of data points received from a LIDAR sensor can result in an increased need for processing power and bandwidth to process the data. Therefore, while an AV travelling at a higher rate of speed may benefit from a LIDAR sensor operating at a higher frequency, the AV may lack the computing resources to operate the LIDAR sensor at the higher frequency. There is therefore a need for increasing the “functional” frequency of a LIDAR sensor, in order to more accurately map the AVs environment without constraining the AVs computing resources. As discussed in more detail below, a “functional” frequency of a LIDAR sensor can include the frequency which LIDAR data for a scan of the LIDAR sensor can be obtained. As further described herein, the “functional” frequency of the LIDAR sensor can differ from the actual physical/hardware frequency of the LIDAR sensor.

Described herein are systems, apparatuses, processes (also referred to as methods), and computer-readable media (collectively referred to as “systems and techniques”) for increasing the functional frequency of a LIDAR sensor without increasing the actual, physical frequency of the LIDAR sensor. In other words, the systems and techniques described herein can increase the frequency in which LIDAR data for a scan of a LIDAR sensor is obtained without necessarily increasing the actual frequency of the scan (e.g., the speed of rotation of the LIDAR sensor during the scan). For example, a LIDAR sensor that is fully rotating can scan the environment during a first portion of a rotation of the LIDAR sensor during a scan, and skip data collection for one or more portions of the rotation of the LIDAR sensor in a scan. The data corresponding to the one or more portions of rotation skipped can be estimated and combined with LIDAR data collected during the first portion of rotation during the scan to generate LIDAR data for a full scan (e.g., for a full rotation) of the LIDAR sensor. The LIDAR data corresponding to the one or more portions of the rotation skipped can be estimated based on the LIDAR data collected in the first portion of the rotation of the LIDAR sensor during the scan and/or other LIDAR data, such as LIDAR data collected in one or more previous scans of the LIDAR sensor By skipping collection of LIDAR data for one or more portions of the rotation of the LIDAR sensor and estimating the LIDAR data for such one or more portions of the rotation, the LIDAR data corresponding to a scan of the LIDAR sensor can be collected and processed faster than waiting for the LIDAR sensor to collect the data for a full scan/rotation. Thus, this process can increase the functional frequency of the LIDAR sensor, as described in more detail below.

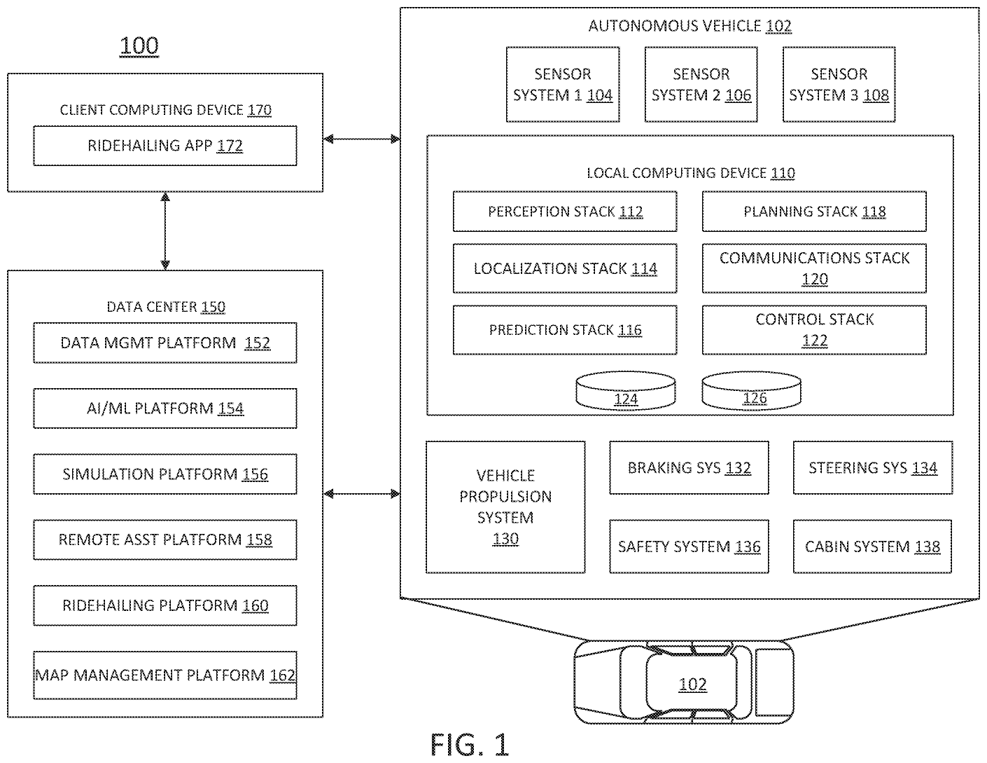

FIG. 1 is a diagram illustrating an example autonomous vehicle (AV) environment 100, according to some examples of the present disclosure. One of ordinary skill in the art will understand that, for AV environment 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV environment 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by multiple sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a localization stack 114, a prediction stack 116, a planning stack 118, a communications stack 120, a control stack 122, an AV operational database 124, and an HD geospatial database 126, among other stacks and systems.

Perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the localization stack 114, the HD geospatial database 126, other components of the AV, and other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the perception stack 112 can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Localization stack 114 can determine the AV's position and orientation (pose) using different methods from multiple systems (e.g., GPS, IMUs, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

Prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

Planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

Control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

Communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). Communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Low Power Wide Area Network (LPWAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

Data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ride-hailing service (e.g., a ridesharing service), a delivery service, a remote/roadside assistance service, street services (e.g., street mapping, street patrol, street cleaning, street metering, parking reservation, etc.), and the like.

Data center 150 can send and receive various signals to and from the AV 102 and the client computing device 170. These signals can include sensor data captured by the sensor systems 104-108, roadside assistance requests, software updates, ride-hailing/ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ride-hailing platform 160, and a map management platform 162, among other systems.

Data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ride-hailing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ride-hailing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

Simulation platform 156 can enable testing and validation of the algorithms, machine learning models, neural networks, and other development efforts for the AV 102, the remote assistance platform 158, the ride-hailing platform 160, the map management platform 162, and other platforms and systems. Simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from a cartography platform (e.g., map management platform 162); modeling the behavior of other vehicles, bicycles, pedestrians, and other dynamic elements; simulating inclement weather conditions, different traffic scenarios; and so on.

Remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

Ride-hailing platform 160 can interact with a customer of a ride-hailing service via a ride-hailing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ride-hailing application 172. The client computing device 170 can be a customer's mobile computing device or a computing device integrated with the AV 102 (e.g., the local computing device 110). The ride-hailing platform 160 can receive requests to pick up or drop off from the ride-hailing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some embodiments, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ride-hailing platform 160 may incorporate the map viewing services into the client application 172 to enable passengers to view the AV 102 in transit en route to a pick-up or drop-off location, and so on.

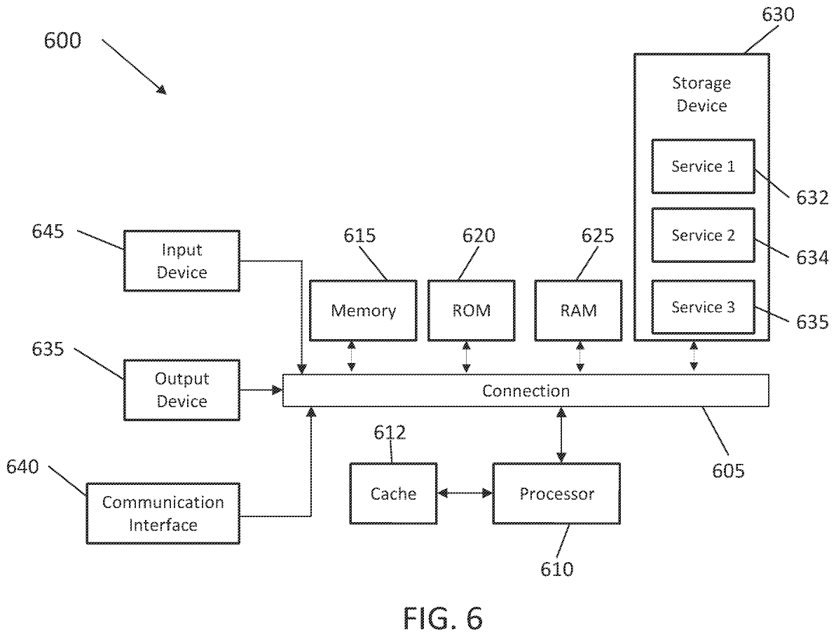

While the autonomous vehicle 102, the local computing device 110, and the autonomous vehicle environment 100 are shown to include certain systems and components, one of ordinary skill will appreciate that the autonomous vehicle 102, the local computing device 110, and/or the autonomous vehicle environment 100 can include more or fewer systems and/or components than those shown in FIG. 1. For example, the autonomous vehicle 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 6.

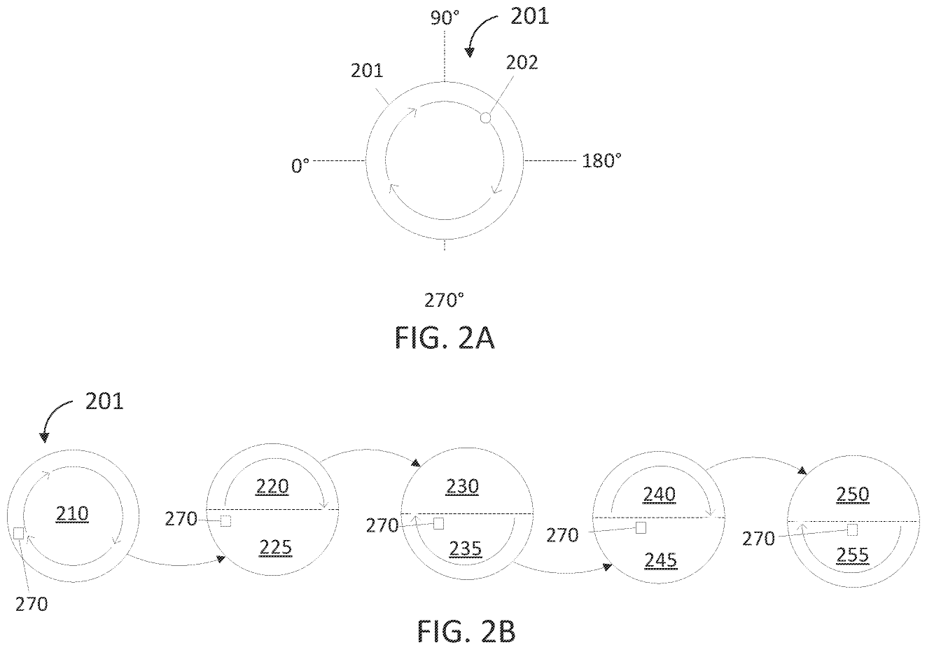

FIG. 2A illustrates a diagram of an example LIDAR sensor 201. As described above, a LIDAR sensor 201 is one type of sensor that can be used by AVs to help navigate roadways. In some examples, the LIDAR sensor 201 includes an emitter/receiver 202 that can emit light waves into the environment that can bounce off surrounding objects and return to the sensor. The LIDAR sensor 201 can calculate the distance that the light waves travelled based on how long it takes for a pulse to return to the emitter/receiver 202. As illustrated by the arrows in FIG. 2A, the emitter/receiver 202 within the LIDAR sensor 201 can rotate as it is emitting and receiving the light waves, and this process can be repeated to create a map of the AV's environment. Although the arrows in FIGS. 2A and 2B are illustrated rotating in the clockwise direction, the emitter/receiver 202 can rotate in any direction.

Moreover, while the examples provided herein describe rotation as the movement of a LIDAR sensor during a LIDAR scan/cycle, the systems and techniques described herein can be applied to any LIDAR sensor that moves and/or changes its field-of-view (FOV) in any other manner while collecting data for a cycle of movement and/or FOV changes. For example, a LIDAR sensor on a platform can be configured to collect data as it moves along one or more planes with or without rotating about an axis. In such examples, the LIDAR sensor can similarly collect data during a portion of a cycle of movement and/or FOV changes while skipping data collection during another portion(s) of the cycle of movement and/or FOV changes. The data corresponding to the portion(s) of the cycle of movement and/or FOV changes can be estimated and combined with the data that was actually collected by the LIDAR sensor during the portion of the cycle of movement and/or FOV changes to generate data for a full cycle of movement and/or FOV changes of the LIDAR sensor. Further, while the LIDAR sensors and LIDAR data described herein are described in the context of a vehicle (e.g., an AV), the vehicle use case is merely one illustrative example provided for explanation purposes. The systems and techniques described herein can be implemented with LIDAR sensors and LIDAR data in any other context or use case, such as LIDAR sensors on an aircraft, a robotic device, and/or any other LIDAR application.

In general, the more times the emitter/receiver 202 of the LIDAR sensor 201 fully rotate (e.g., the higher the frequency of the LIDAR sensor 201), the more data that the LIDAR sensor 201 can collect. For example, the more times the emitter/receiver 202 rotates per unit of time, the more data the LIDAR sensor 201 can capture, thereby providing more accurate and/or complete information about the surrounding environment. A higher frequency LIDAR sensor 201 can also be useful when an AV is travelling at a high rate of speed (e.g., at a speed above a threshold) since objects proximate to the AV can be located within the field of view of the LIDAR sensor 201 for a shorter period of time than if the AV was traveling slower, due to the higher speed of the AV. However, there can be constraints on the ability to increase the actual, physical/hardware frequency of a LIDAR sensor 201 (such as hardware or computing constraints). Therefore, it can be beneficial to increase the frequency in which data is collected by a LIDAR sensor 201 for a data collection cycle of the LIDAR sensor 201, such as a scan of the LIDAR sensor 201. However, hardware or computing constraints can limit the ability to physically increase this frequency. One way to increase the amount of LIDAR data obtained for a scan of the LIDAR sensor 201 is to increase the functional frequency of the LIDAR sensor 201 as described in more detail below.

FIG. 2B illustrates a diagram of an example LIDAR sensor 201 using estimation techniques to increase the functional frequency of the LIDAR sensor 201 without increasing the actual, physical frequency of the LIDAR sensor 201. In this example, the LIDAR sensor 201 can perform at least one full scan 210 of the environment by emitting and receiving light waves while rotating. The full scan can include a full rotation of the LIDAR sensor 201 or a partial rotation from a beginning position to an end position associated with the scan. In other cases, the full scan can involve other type of movement and/or FOV changes, such as moving along a vertical plane (e.g., relative to an axis of the LIDAR sensor 201), a horizontal plane, and/or any other plane. In some cases, a full scan can include any other type of movement and/or FOV changes of the LIDAR sensor 201.

During a scan 210, the LIDAR sensor 201 can collect data. The collected data can be used to measure information about any objects located within the field of view of the LIDAR sensor 201 during the scan. For example, as shown in FIG. 2B, a light wave can be emitted from the emitter/receiver of LIDAR sensor 201 (e.g., emitter/receiver 202 illustrated in FIG. 2A), and that light wave can reflect off any object located within the FOV of the LIDAR sensor 201 (e.g., object 270) and the reflected light wave can return to the emitter/receiver of LIDAR sensor 201. A light wave that is reflected off an object in the FOV of the LIDAR sensor 201 and returned to the LIDAR sensor 201 can constitute data collected by the LIDAR sensor 201. As shown in FIG. 2B, LIDAR sensor 201 can collect data indicating the presence of an object (e.g., object 270) within the FOV of the LIDAR sensor 201 during the scan 210. In some cases, to increase the frequency of the LIDAR sensor 201 and/or a frequency in which data for a full scan of the LIDAR sensor 201 is obtained, the LIDAR sensor 201 can collect data during a first portion of rotation (or any other movement of the LIDAR sensor 201 during a scan) of a scan cycle (e.g., the top part 220 in FIG. 2B), while estimating the data corresponding to a second portion of rotation (or any other movement of the LIDAR sensor 201 during a scan) of a scan cycle (e.g., the bottom part 225 in FIG. 2B).

For example, the LIDAR sensor 201 can collect LIDAR data from a FOV of the LIDAR sensor 201 while the LIDAR sensor 201 is within the first portion of rotation (e.g., top part 220) of a scan cycle of the LIDAR sensor 201, and skip collection of LIDAR data from a FOV of the LIDAR sensor 201 while the LIDAR sensor 201 is within the second portion of rotation (e.g., bottom part 225). Using data collected by the LIDAR sensor 201 during one or more scans and/or one or more portions of one or more scans (and/or data from another sensor), the LIDAR data measuring a portion of a scene that is within the FOV of the LIDAR sensor 201 while the LIDAR sensor 201 is within the second portion of rotation can be estimated (e.g., since the LIDAR sensor 201 skipped collection of LIDAR data from the second portion of rotation of the scan cycle). The estimated LIDAR data can be combined or fused with the LIDAR data collected by the LIDAR sensor 201 during the first portion of rotation of the scan to generate LIDAR for the full scan cycle (e.g., for the full rotation of the LIDAR sensor 201).

In some examples, state estimation can be used to estimate the LIDAR data corresponding to the second portion of rotation of the scan cycle (e.g., which the LIDAR sensor 201 did not collect LIDAR data for/from) based, at least in part, on the measured trajectory of an object (e.g., object 270) within the portion of the scene that is within the FOV of the LIDAR sensor 201 while the LIDAR sensor 201 is within the second portion of rotation of the scan cycle, for which the LIDAR sensor 201 skipped data collection. The trajectory of the object can be determined using a computing system (such as, for example, computing system 600 described below). In some examples, a machine learning model(s) can be implemented to estimate the LIDAR data (e.g., the location of object 270) that the LIDAR sensor 201 did not collect because it skipped data collection for the second portion of rotation of the scan cycle (e.g., the bottom part 225). After the LIDAR sensor 201 has scanned the top part 220 and a computing system has estimated the data corresponding to the second portion of rotation (e.g., the bottom part 225) of the scan cycle, the computing system can combine the collected LIDAR data with the estimated LIDAR data to generate LIDAR data for a full scan/rotation of the LIDAR sensor 201 (e.g., for the top part 220 and the bottom part 225). Therefore, for each complete physical rotation of LIDAR sensor 201, two data sets can be produced including scanned data and estimated data, thereby effectively increasing (e.g., doubling) the frequency of the LIDAR sensor 201 without physically increasing the actual frequency of the LIDAR sensor 201. This process can be repeated for any number of scans, thereby producing more LIDAR data in the same time period that otherwise produced by the LIDAR sensor 201 with conventional scanning. For example, after the bottom part 235 is scanned, the top part 240 can be scanned, while the location of object 270 is estimated within the bottom part 245 (based on the location of object 270 during the previous scan of bottom part 235). Location data related to any objects sensed during the scan of top part 240 can be used to estimate location data related to the same or other objects within the top part 250, while the bottom part 255 is scanned.

In some scenarios, a gap in the field of view of LIDAR sensor 201 can exist at the location of the dividing line (e.g., the dotted lines illustrated in FIG. 2B) wherein nothing is scanned or estimated thereby producing a blind spot. The dividing line can be placed at any location within the LIDAR sensor 201 FOV. However, it can be beneficial to place the dividing line (e.g., the dotted lines illustrated in FIG. 2B) at a location with the least potential to affect the data collection of the LIDAR sensor 201. For example, when the AV is proceeding in the forward direction, placing the dividing line in the horizontal middle (e.g., from 0 degrees to 180 degrees) allows the LIDAR sensor 201 to scan the environment in front of the AV as well as behind the AV, while leaving a potential blind spot on either side of the AV. This scenario can mimic the operation of a human driver who is driving forward and mostly focusing on the road ahead of the vehicle and also occasionally checking behind the vehicle. However, in a scenario where the driver wishes to make a turn or change lanes, the human driver can look to the side to confirm that the maneuver is safe. In such a scenario, when the AV plans to turn, the computing system of the AV can dynamically change the location of the diving line of LIDAR sensor 201 from a horizontal line (e.g., from 0 degrees to 180 degrees) to a vertical line (e.g., from 90 degrees to 270 degrees). This can assure that there is no blind spot on the side of the AV and permit safe maneuvering.

The computing device 110 of AV 102 can dynamically adjust the location of the dividing line (e.g., the dotted lines illustrated in FIG. 2B) within LIDAR sensor 201 as the AV 102 traverses the roadway in a manner that provides the best coverage of the environment around AV 102 accounting for the various maneuvers of the AV. In addition to placing the dividing line in the two positions described above (e.g., middle horizontal and middle vertical), the dividing line can be placed at any location within the LIDAR sensor 201. Further, LIDAR sensor 201 can be divided into more than two parts, and in fact can be divided into any number of parts. In the scenario where the LIDAR sensor 201 has been divided into more than two parts, the LIDAR sensor 201 will only scan one part at a time and estimate the data associated with the remaining parts, before continuing to scan the second part and estimating the data associated with the remaining parts. Therefore, the more parts that the LIDAR sensor 201 is divided into, the more parts will comprise estimated data, which can produce additional uncertainty. Additionally, an increased number of dividing lines can produce an increased number of blind spots. So, while multiple dividing lines can produce a faster operating LIDAR sensor 201, it can also lead to increased uncertainty.

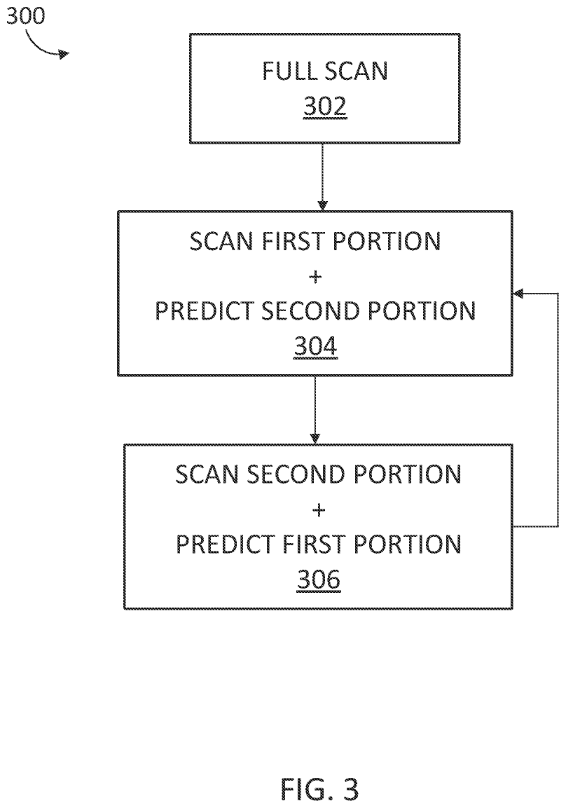

FIG. 3 illustrates a flow diagram of an example process 300 for increasing the functional frequency of a LIDAR sensor without physically increasing the frequency. At block 302, the process 300 can include performing at least one scan of the environment surrounding the LIDAR sensor by emitting and receiving light waves. During this scan, the LIDAR sensor (e.g., LIDAR sensor 201) can collect data. As described above, the collected data can be used to measure information about any objects located within the field of view of the LIDAR sensor during the scan. For example, as discussed above with reference to FIG. 2B, a light wave can be emitted from the emitter/receiver of LIDAR sensor 201 (e.g., emitter/receiver 202 illustrated in FIG. 2A), and that light wave can reflect off any object located within the LIDAR sensor 201 FOV (e.g., object 270 in FIG. 2B) and the reflected light wave can return to the emitter/receiver of LIDAR sensor. A light wave that is reflected off of an object in the LIDAR sensor FOV and returned to the LIDAR sensor emitter/receiver can constitute data collected by the LIDAR sensor. At block 304, the process 300 can include scanning a first portion (e.g., the top part 220 illustrated in FIG. 2B) of the environment to collect LIDAR data for the first portion of the environment, while estimating the LIDAR data for a second portion (e.g., the bottom part 225 illustrated in FIG. 2B) of the environment. For example, LIDAR data relating to an object located within the LIDAR sensor FOV collected during the first portion of the scan at block 302 can be used to estimate LIDAR data indicating the location of the object during the second portion of the scan that was skipped by the LIDAR sensor (e.g., the bottom part 225 illustrated in FIG. 2B). In some examples, state estimation can be used to estimate the data indicating the location of the object based, at least in part, on the measured velocity and classification of the object that can be determined using a computing system. In some examples, machine learning models can be implemented to estimate the location of the object within part B (e.g., the bottom part 225 illustrated in FIG. 2B).

At block 306, the process 300 can include predicting the location of any objects previously scanned in part A (e.g., the top part 220 illustrated in FIG. 2B) for the next cycle (e.g., top part 230 illustrated in FIG. 2B), and scanning part B (e.g., the bottom part 235 illustrated in FIG. 2B). This process can produce two data sets (e.g., both data sets comprising partly scanned data and partly estimated data) for each complete physical rotation of LIDAR sensor 201. As indicated by the arrow from block 306 to block 304, this process can be repeated indefinitely, thereby producing twice the number of data sets in the same time period. It is further contemplated that the LIDAR sensor 201 can be divided into more than two parts (e.g., part A and part B), and in such a scenario the process would proceed in the same manner. For example, part A would be scanned first while the remaining parts (no matter how many parts) would be predicated based on previous scanned. Subsequently, part B would be scanned next while the remaining parts (no matter how many parts) would be predicated based on previous scanned. Then, part C would be scanned next while the remaining parts (no matter how many parts) would be predicated based on previous scanned. This process can continue until all parts have been scanned once (while the other parts are predicted), and then repeated indefinitely.

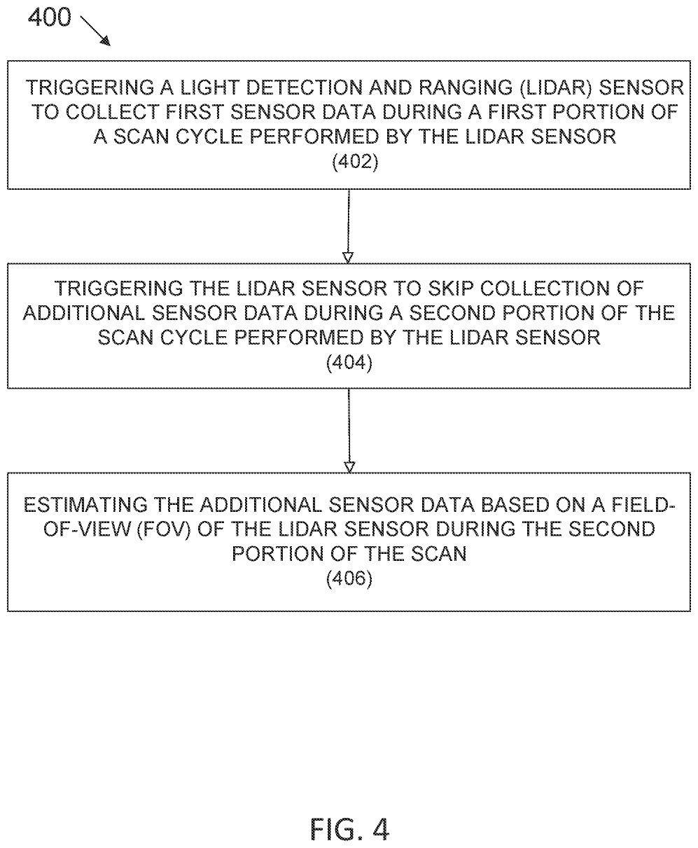

FIG. 4 illustrates a flow diagram of an example process 400 for increasing the functional frequency of a LIDAR sensor without physically increasing the frequency. At block 402, the process 400 can include triggering a light detection and ranging (LIDAR) sensor (e.g., LIDAR sensor 201) to collect first sensor data during a first portion of a scan cycle performed by the LIDAR sensor. For example, LIDAR sensor 201 can scan a first part (e.g., the top part 220 in FIG. 2B). In some examples, a scan performed by LIDAR sensor 201 can include emitting pulsed light waves into the environment that can bounce off surrounding objects and return to the LIDAR sensor 201. The LIDAR sensor can calculate the distance that the light waves travelled based on how long it takes for a pulse to return to the sensor.

At block 404, the process 400 can include triggering the LIDAR sensor (e.g., LIDAR sensor 201) to skip collection of additional sensor data during a second portion of the scan cycle performed by the LIDAR sensor. For example, LIDAR sensor 201 can skip scanning top portion 230 in FIG. 2B. At block 406, the process 400 can include estimating the additional sensor data (e.g., top portion 230 in FIG. 2B) based on a field-of-view (FOV) of the LIDAR sensor during the second portion of the scan (e.g., LIDAR sensor 201). For example, after the bottom part 235 is scanned, the top part 240 can be scanned, while the location of object 270 is estimated within the bottom part 245 (based on the location of object 270 during the previous scan of bottom part 235. And, subsequently, location data relating to any objects located within the LIDAR sensor FOV during the scan of top part 240 can be used to estimated a location of that object within the top part 250, while the bottom part 255 is scanned. For example, after the LIDAR sensor 201 has scanned the top part 220, the LIDAR sensor 201 can estimate the location of any objects scanned in the top part 220 for the next cycle (e.g., top part 230), while subsequently scanning the bottom part 235. Therefore, for each complete physical rotation of LIDAR sensor 201, two data sets can be produced (e.g., both data sets comprising partly scanned data and partly estimated data), thereby effectively doubling the frequency of the LIDAR sensor 201 without physically doubling the frequency. This process can be repeated indefinitely, thereby producing twice the number of data sets in the same time period as single data can be produced with conventional scanning.

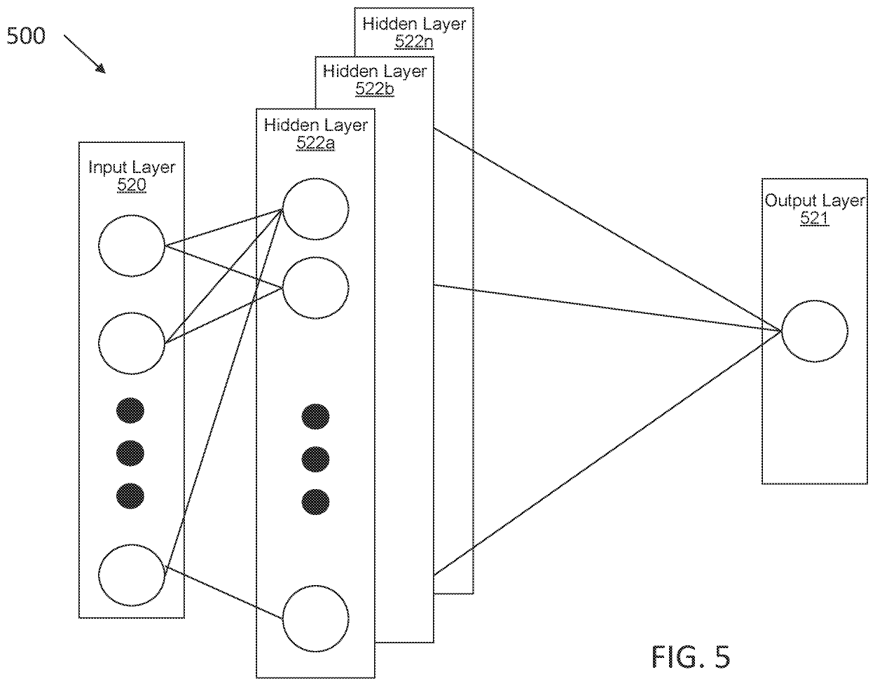

In FIG. 5, the disclosure now turns to a further discussion of models that can be used through the environments and techniques described herein. FIG. 5 is an example of a deep learning neural network 500 that can be used to implement all or a portion of the systems and techniques described herein (e.g., neural network 500 can be used to estimate the location of objects within a field of view of a LIDAR scanner as discussed above). An input layer 520 can be configured to receive sensor data and/or data relating to an environment surrounding an AV. Neural network 500 includes multiple hidden layers 522a, 522b, through 522n. The hidden layers 522a, 522b, through 522n include “n” number of hidden layers, where “n” is an integer greater than or equal to one. The number of hidden layers can be made to include as many layers as needed for the given application. Neural network 500 further includes an output layer 521 that provides an output resulting from the processing performed by the hidden layers 522a, 522b, through 522n.

Neural network 500 is a multi-layer neural network of interconnected nodes. Each node can represent a piece of information. Information associated with the nodes is shared among the different layers and each layer retains information as information is processed. In some cases, the neural network 500 can include a feed-forward network, in which case there are no feedback connections where outputs of the network are fed back into itself. In some cases, the neural network 500 can include a recurrent neural network, which can have loops that allow information to be carried across nodes while reading in input.

Information can be exchanged between nodes through node-to-node interconnections between the various layers. Nodes of the input layer 520 can activate a set of nodes in the first hidden layer 522a. For example, as shown, each of the input nodes of the input layer 520 is connected to each of the nodes of the first hidden layer 522a. The nodes of the first hidden layer 522a can transform the information of each input node by applying activation functions to the input node information. The information derived from the transformation can then be passed to and can activate the nodes of the next hidden layer 522b, which can perform their own designated functions. Example functions include convolutional, up-sampling, data transformation, and/or any other suitable functions. The output of the hidden layer 522b can then activate nodes of the next hidden layer, and so on. The output of the last hidden layer 522n can activate one or more nodes of the output layer 521, at which an output is provided. In some cases, while nodes in the neural network 500 are shown as having multiple output lines, a node can have a single output and all lines shown as being output from a node represent the same output value.

In some cases, each node or interconnection between nodes can have a weight that is a set of parameters derived from the training of the neural network 500. Once the neural network 500 is trained, it can be referred to as a trained neural network, which can be used to classify one or more activities. For example, an interconnection between nodes can represent a piece of information learned about the interconnected nodes. The interconnection can have a tunable numeric weight that can be tuned (e.g., based on a training dataset), allowing the neural network 500 to be adaptive to inputs and able to learn as more and more data is processed.

The neural network 500 is pre-trained to process the features from the data in the input layer 520 using the different hidden layers 522a, 522b, through 522n in order to provide the output through the output layer 521.

In some cases, the neural network 500 can adjust the weights of the nodes using a training process called backpropagation. A backpropagation process can include a forward pass, a loss function, a backward pass, and a weight update. The forward pass, loss function, backward pass, and parameter/weight update is performed for one training iteration. The process can be repeated for a certain number of iterations for each set of training data until the neural network 500 is trained well enough so that the weights of the layers are accurately tuned.

To perform training, a loss function can be used to analyze error in the output. Any suitable loss function definition can be used, such as a Cross-Entropy loss. Another example of a loss function includes the mean squared error (MSE), defined as E_total=Σ(½ (target-output)\hat{ }2). The loss can be set to be equal to the value of E_total.

The loss (or error) will be high for the initial training data since the actual values will be much different than the predicted output. The goal of training is to minimize the amount of loss so that the predicted output is the same as the training output. The neural network 500 can perform a backward pass by determining which inputs (weights) most contributed to the loss of the network, and can adjust the weights so that the loss decreases and is eventually minimized.

The neural network 500 can include any suitable deep network. One example includes a Convolutional Neural Network (CNN), which includes an input layer and an output layer, with multiple hidden layers between the input and out layers. The hidden layers of a CNN include a series of convolutional, nonlinear, pooling (for downsampling), and fully connected layers. The neural network 500 can include any other deep network other than a CNN, such as an autoencoder, Deep Belief Nets (DBNs), Recurrent Neural Networks (RNNs), among others.

As understood by those of skill in the art, machine-learning based classification techniques can vary depending on the desired implementation. For example, machine-learning classification schemes can utilize one or more of the following, alone or in combination: hidden Markov models; RNNs; CNNs; deep learning; Bayesian symbolic methods; Generative Adversarial Networks (GANs); support vector machines; image registration methods; and applicable rule-based systems. Where regression algorithms are used, they may include but are not limited to: a Stochastic Gradient Descent Regressor, a Passive Aggressive Regressor, etc.

Machine learning classification models can also be based on clustering algorithms (e.g., a Mini-batch K-means clustering algorithm), a recommendation algorithm (e.g., a Minwise Hashing algorithm, or Euclidean Locality-Sensitive Hashing (LSH) algorithm), and/or an anomaly detection algorithm, such as a local outlier factor. Additionally, machine-learning models can employ a dimensionality reduction approach, such as, one or more of: a Mini-batch Dictionary Learning algorithm, an incremental Principal Component Analysis (PCA) algorithm, a Latent Dirichlet Allocation algorithm, and/or a Mini-batch K-means algorithm, etc.

FIG. 6 illustrates an example processor-based system with which some aspects of the subject technology can be implemented. For example, processor-based system 600 can be any computing device making up, or any component thereof in which the components of the system are in communication with each other using connection 605. Connection 605 can be a physical connection via a bus, or a direct connection into processor 610, such as in a chipset architecture. Connection 605 can also be a virtual connection, networked connection, or logical connection.

In some embodiments, computing system 600 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 600 includes at least one processing unit (Central Processing Unit (CPU) or processor) 610 and connection 605 that couples various system components including system memory 615, such as Read-Only Memory (ROM) 620 and Random-Access Memory (RAM) 625 to processor 610. Computing system 600 can include a cache of high-speed memory 612 connected directly with, in close proximity to, or integrated as part of processor 610.

Processor 610 can include any general-purpose processor and a hardware service or software service, such as services 632, 634, and 636 stored in storage device 630, configured to control processor 610 as well as a special-purpose processor where software instructions are incorporated into the actual processor design. Processor 610 may essentially be a completely self-contained computing system, containing multiple cores or processors, a bus, memory controller, cache, etc. A multi-core processor may be symmetric or asymmetric.

To enable user interaction, computing system 600 includes an input device 645, which can represent any number of input mechanisms, such as a microphone for speech, a touch-sensitive screen for gesture or graphical input, keyboard, mouse, motion input, speech, etc. Computing system 600 can also include output device 635, which can be one or more of a number of output mechanisms known to those of skill in the art. In some instances, multimodal systems can enable a user to provide multiple types of input/output to communicate with computing system 600. Computing system 600 can include communications interface 640, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 640 may also include one or more Global Navigation Satellite System (GNSS) receivers or transceivers that are used to determine a location of the computing system 600 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 630 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 630 can include software services, servers, services, etc., that when the code that defines such software is executed by the processor 610, it causes the system 600 to perform a function. In some embodiments, a hardware service that performs a particular function can include the software component stored in a computer-readable medium in connection with the necessary hardware components, such as processor 610, connection 605, output device 635, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

Illustrative examples of the disclosure include:

Aspect 1. A system comprising: at least one memory; and at least one processor coupled to the at least one memory, the at least one processor configured to: trigger a light detection and ranging (LIDAR) sensor to collect first sensor data during a first portion of a scan cycle performed by the LIDAR sensor; trigger the LIDAR sensor to skip collection of additional sensor data during a second portion of the scan cycle performed by the LIDAR sensor; and estimate the additional sensor data based on a field-of-view (FOV) of the LIDAR sensor during the second portion of the scan.

Aspect 2. The system of Aspect 1, wherein the first portion of the scan comprises a first partial rotation of the LIDAR sensor during a rotation cycle performed by the LIDAR sensor, wherein the second portion of the scan comprises a second partial rotation of the LIDAR sensor during the rotation cycle, wherein a third portion of the scan comprises a third partial rotation of the LIDAR sensor during a rotation cycle, and wherein the rotation cycle comprises at least the first partial rotation, the second partial rotation, and the third partial rotation.

Aspect 3. The system of Aspect 1 or 2, wherein the first sensor data corresponds to one or more first FOVs of the LIDAR sensor during the first portion of the scan, and the second sensor data corresponds to one or more second FOVs of the LIDAR sensor during the second portion of the scan.

Aspect 4. The system of any of Aspects 1 to 3, wherein the at least one processor is configured to dynamically determine at least one of a start position or an angle of the LIDAR sensor during the first portion of the scan and an end position or angle of the LIDAR sensor during the first portion of the scan based on an operation of an autonomous vehicle (AV).

Aspect 5. The system of any of Aspects 1 to 4, wherein the at least one processor is configured to dynamically adjust an angle of coverage of at least one of the first portion of the scan, and the second portion of the scan based on an operation of an autonomous vehicle (AV).

Aspect 6. The system of any of Aspects 1 to 5, wherein an angle of rotation of the LIDAR sensor during the first portion of the scan comprises half or less than half of a rotation cycle of the LIDAR sensor, wherein the scan comprises the rotation cycle.

Aspect 7. The system of any of Aspects 1 to 6, wherein the at least one processor is configured to generate aggregated sensor data representing a complete cycle of the scan, the aggregated sensor data comprising the first sensor data and the second sensor data.

Aspect 8. triggering a light detection and ranging (LIDAR) sensor to collect first sensor data during a first portion of a scan cycle performed by the LIDAR sensor; triggering the LIDAR sensor to skip collection of additional sensor data during a second portion of the scan cycle performed by the LIDAR sensor; and estimating the additional sensor data based on a field-of-view (FOV) of the LIDAR sensor during the second portion of the scan.

Aspect 9. The method of Aspect 8, wherein the first portion of the scan comprises a first partial rotation of the LIDAR sensor during a rotation cycle performed by the LIDAR sensor, wherein the second portion of the scan comprises a second partial rotation of the LIDAR sensor during the rotation cycle, wherein a third portion of the scan comprises a third partial rotation of the LIDAR sensor during a rotation cycle, and wherein the rotation cycle comprises at least the first partial rotation, the second partial rotation, and the third partial rotation.

Aspect 10. The method of Aspect 8 or 9, wherein the first sensor data corresponds to one or more first FOVs of the LIDAR sensor during the first portion of the scan, and the second sensor data corresponds to one or more second FOVs of the LIDAR sensor during the second portion of the scan.

Aspect 11. The method of any of Aspects 8 to 10, further comprising: dynamically determine at least one of a start position or an angle of the LIDAR sensor during the first portion of the scan and an end position or angle of the LIDAR sensor during the first portion of the scan based on an operation of an autonomous vehicle (AV).

Aspect 12. The method of any of Aspects 8 to 11, further comprising: dynamically adjust an angle of coverage of at least one of the first portion of the scan, and the second portion of the scan based on an operation of an autonomous vehicle (AV).

Aspect 13. The method of any of Aspects 8 to 12, wherein an angle of rotation of the LIDAR sensor during the first portion of the scan comprises half or less than half of a rotation cycle of the LIDAR sensor, wherein the scan comprises the rotation cycle.

Aspect 14. The method of any of Aspects 8 to 13, further comprising: generating aggregated sensor data representing a complete cycle of the scan, the aggregated sensor data comprising the first sensor data and the second sensor data.

Aspect 15. A non-transitory computer-readable storage medium comprising at least one instruction for causing a computer or processor to: trigger a light detection and ranging (LIDAR) sensor to collect first sensor data during a first portion of a scan cycle performed by the LIDAR sensor; trigger the LIDAR sensor to skip collection of additional sensor data during a second portion of the scan cycle performed by the LIDAR sensor; and estimate the additional sensor data based on a field-of-view (FOV) of the LIDAR sensor during the second portion of the scan.

Aspect 16. The non-transitory computer-readable storage medium of Aspect 15, wherein the first portion of the scan comprises a first partial rotation of the LIDAR sensor during a rotation cycle performed by the LIDAR sensor, wherein the second portion of the scan comprises a second partial rotation of the LIDAR sensor during the rotation cycle, wherein a third portion of the scan comprises a third partial rotation of the LIDAR sensor during a rotation cycle, and wherein the rotation cycle comprises at least the first partial rotation, the second partial rotation, and the third partial rotation.

Aspect 17. The non-transitory computer-readable storage medium of Aspect 15 or 16, wherein the first sensor data corresponds to one or more first FOVs of the LIDAR sensor during the first portion of the scan, and the second sensor data corresponds to one or more second FOVs of the LIDAR sensor during the second portion of the scan.

Aspect 18. The non-transitory computer-readable storage medium of any of Aspects 15 to 17, further comprising: dynamically determine at least one of a start position or an angle of the LIDAR sensor during the first portion of the scan and an end position or angle of the LIDAR sensor during the first portion of the scan based on an operation of an autonomous vehicle (AV).

Aspect 19. The non-transitory computer-readable storage medium of any of Aspects 15 to 18, further comprising: dynamically adjust an angle of coverage of at least one of the first portion of the scan, and the second portion of the scan based on an operation of an autonomous vehicle (AV).

Aspect 20. The non-transitory computer-readable storage medium of any of Aspects 15 to 19, wherein an angle of rotation of the LIDAR sensor during the first portion of the scan comprises half or less than half of a rotation cycle of the LIDAR sensor, wherein the scan comprises the rotation cycle.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A system comprising:
at least one memory; and
at least one processor coupled to the at least one memory, the at least one processor configured to:
trigger a light detection and ranging (LIDAR) sensor to collect first sensor data during a first portion of a scan cycle performed by the LIDAR sensor;
trigger the LIDAR sensor to skip collection of additional sensor data during a second portion of the scan cycle performed by the LIDAR sensor; and
estimate the additional sensor data based on a field-of-view (FOV) of the LIDAR sensor during the second portion of the scan.

2. The system of claim 1, wherein the first portion of the scan comprises a first partial rotation of the LIDAR sensor during a rotation cycle performed by the LIDAR sensor, wherein the second portion of the scan comprises a second partial rotation of the LIDAR sensor during the rotation cycle, wherein a third portion of the scan comprises a third partial rotation of the LIDAR sensor during a rotation cycle, and wherein the rotation cycle comprises at least the first partial rotation, the second partial rotation, and the third partial rotation.

3. The system of claim 1, wherein the first sensor data corresponds to one or more first FOVs of the LIDAR sensor during the first portion of the scan, and the second sensor data corresponds to one or more second FOVs of the LIDAR sensor during the second portion of the scan.

4. The system of claim 1, wherein the at least one processor is configured to dynamically determine at least one of a start position or an angle of the LIDAR sensor during the first portion of the scan and an end position or angle of the LIDAR sensor during the first portion of the scan based on an operation of an autonomous vehicle (AV).

5. The system of claim 1, wherein the at least one processor is configured to dynamically adjust an angle of coverage of at least one of the first portion of the scan, and the second portion of the scan based on an operation of an autonomous vehicle (AV).

6. The system of claim 1, wherein an angle of rotation of the LIDAR sensor during the first portion of the scan comprises half or less than half of a rotation cycle of the LIDAR sensor, wherein the scan comprises the rotation cycle.

7. The system of claim 1, wherein the at least one processor is configured to generate aggregated sensor data representing a complete cycle of the scan, the aggregated sensor data comprising the first sensor data and the second sensor data.

8. A method comprising:
triggering a light detection and ranging (LIDAR) sensor to collect first sensor data during a first portion of a scan cycle performed by the LIDAR sensor;
triggering the LIDAR sensor to skip collection of additional sensor data during a second portion of the scan cycle performed by the LIDAR sensor; and
estimating the additional sensor data based on a field-of-view (FOV) of the LIDAR sensor during the second portion of the scan.

9. The method of claim 8, wherein the first portion of the scan comprises a first partial rotation of the LIDAR sensor during a rotation cycle performed by the LIDAR sensor, wherein the second portion of the scan comprises a second partial rotation of the LIDAR sensor during the rotation cycle, wherein a third portion of the scan comprises a third partial rotation of the LIDAR sensor during a rotation cycle, and wherein the rotation cycle comprises at least the first partial rotation, the second partial rotation, and the third partial rotation.

10. The method of claim 8, wherein the first sensor data corresponds to one or more first FOVs of the LIDAR sensor during the first portion of the scan, and the second sensor data corresponds to one or more second FOVs of the LIDAR sensor during the second portion of the scan.

11. The method of claim 8, further comprising:
dynamically determine at least one of a start position or an angle of the LIDAR sensor during the first portion of the scan and an end position or angle of the LIDAR sensor during the first portion of the scan based on an operation of an autonomous vehicle (AV).

12. The method of claim 8, further comprising:
dynamically adjust an angle of coverage of at least one of the first portion of the scan, and the second portion of the scan based on an operation of an autonomous vehicle (AV).

13. The method of claim 8, wherein an angle of rotation of the LIDAR sensor during the first portion of the scan comprises half or less than half of a rotation cycle of the LIDAR sensor, wherein the scan comprises the rotation cycle.

14. The method of claim 8, further comprising:
generating aggregated sensor data representing a complete cycle of the scan, the aggregated sensor data comprising the first sensor data and the second sensor data.

15. A non-transitory computer-readable storage medium comprising at least one instruction for causing a computer or processor to:
trigger a light detection and ranging (LIDAR) sensor to collect first sensor data during a first portion of a scan cycle performed by the LIDAR sensor;
trigger the LIDAR sensor to skip collection of additional sensor data during a second portion of the scan cycle performed by the LIDAR sensor; and
estimate the additional sensor data based on a field-of-view (FOV) of the LIDAR sensor during the second portion of the scan.

16. The non-transitory computer-readable storage medium of claim 15, wherein the first portion of the scan comprises a first partial rotation of the LIDAR sensor during a rotation cycle performed by the LIDAR sensor, wherein the second portion of the scan comprises a second partial rotation of the LIDAR sensor during the rotation cycle, wherein a third portion of the scan comprises a third partial rotation of the LIDAR sensor during a rotation cycle, and wherein the rotation cycle comprises at least the first partial rotation, the second partial rotation, and the third partial rotation.

17. The non-transitory computer-readable storage medium of claim 15, wherein the first sensor data corresponds to one or more first FOVs of the LIDAR sensor during the first portion of the scan, and the second sensor data corresponds to one or more second FOVs of the LIDAR sensor during the second portion of the scan.

18. The non-transitory computer-readable storage medium of claim 15, further comprising:
dynamically determine at least one of a start position or an angle of the LIDAR sensor during the first portion of the scan and an end position or angle of the LIDAR sensor during the first portion of the scan based on an operation of an autonomous vehicle (AV).

19. The non-transitory computer-readable storage medium of claim 15, further comprising:
dynamically adjust an angle of coverage of at least one of the first portion of the scan, and the second portion of the scan based on an operation of an autonomous vehicle (AV).

20. The non-transitory computer-readable storage medium of claim 15, wherein an angle of rotation of the LIDAR sensor during the first portion of the scan comprises half or less than half of a rotation cycle of the LIDAR sensor, wherein the scan comprises the rotation cycle.
